(19) United States
(12) Patent Application Publication
(10) Pub. No.: US 2024/0368932 A1
(43) Pub. Date: Nov. 7, 2024

(54) METHOD FOR CHECKING AN OPENING MOVEMENT AND/OR A CLOSING MOVEMENT OF A MOTOR VEHICLE BODY SYSTEM ABLE TO BE ACTUATED BY AN EXTERNAL FORCE

(71) Applicant: Dr. Ing. h.c. F. Porsche Aktiengesellschaft, Stuttgart (DE)

(72) Inventors: Georg GEBERT, Stuttgart (DE); Moritz SCHMIDT, Tamm (DE); Reiner ARMBRUSTER, Muehlacker (DE)

(21) Appl. No.: 18/650,116

(22) Filed: Apr. 30, 2024

(30) Foreign Application Priority Data
May 3, 2023 (DE) 10 2023 111 359.3

(51) Int. Cl. E05F 15/46

(52) U.S. Cl. CPC E05F 15/46; E05Y 2400/44; E05Y 2900/50

(57) ABSTRACT

A method for checking an opening and/or closing movement of a motor vehicle body system, including energizing an electric drive device of the vehicle body system such that a movement of the vehicle body system is driven from a closed to open position or open to closed position, and measuring a drive current signal during energizing. The method further includes checking whether predefined or predefinable current changes given by current gradients and amplitudes occur in the drive current signal and whether the predefined or predefinable current changes exceed or undershoot a predefined or predefinable value during the opening and/or closing operation of the vehicle body system, and/or whether a predefined or predefinable current limit value is exceeded or undershot in the drive current signal during a pinching event within a predefined or predefinable path and/or time interval during the opening and/or closing operation of the vehicle body system.

### CROSS REFERENCE TO RELATED APPLICATIONS

This application claims benefit to German Patent Application No. DE 10 2023 111 359.3, filed on May 3, 2023, which is hereby incorporated by reference herein.

### FIELD

The present invention relates to a method for checking an opening movement and/or a closing movement of a motor vehicle body system able to be actuated by an external force.

### BACKGROUND

Various embodiments of vehicle body systems able to be actuated by an external force are known from the prior art. One technical common feature of such vehicle body systems able to be actuated by an external force is that they comprise an electric drive device, by means of which the opening movement of the vehicle body system can be driven from a closed position to an open position and/or the closing movement of the vehicle body system can be driven from an open position to a closed position. Examples of motor vehicle body systems able to be actuated by an external force include roof opening systems, in particular sliding roof systems or convertible top systems, in particular side windows, doors, trunk lids, tailgates and front lids, the opening movement and/or closing movement of which can be driven by means of an electric drive device associated with each of these.

Practical experience has shown that the quality of roof opening systems, in particular sliding roof systems, is dependent on manufacturing tolerances of the mechanical components to a particular extent. In electromotor-driven windows, in particular side windows, doors comprising an electromotor-driven automatic closing system, trunk lids, tailgates and front lids, it is also important to provide effective pinch protection. Legal requirements are placed on such pinch protection of vehicle body systems able to be actuated by an external force, in particular with regard to the maximum clamping forces to be observed. Compliance is currently ensured by means of a relatively complex mechanical force measurement in both the development and the manufacturing processes.

### SUMMARY

In an embodiment, the present disclosure provides a method for checking an opening movement and/or a closing movement of a motor vehicle body system able to be actuated by an external force, the method comprising energizing an electric drive device of the vehicle body system such that a movement of the vehicle body system is driven from a closed position to an open position or from the open position to the closed position and measuring a drive current signal during energizing of the electric drive device. The method further comprises checking whether predefined or predefinable current changes, which are given by current gradients and current amplitudes, occur in the drive current signal and whether the predefined or predefinable current changes exceed or undershoot a predefined or predefinable value during the opening and/or closing operation of the vehicle body system, and/or whether a predefined or predefinable current limit value is exceeded or undershot in the drive current signal during a pinching event within a predefined or predefinable path and/or time interval during the opening and/or closing operation of the vehicle body system.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates the basic sequence of a method for checking an opening movement and/or closing movement of a vehicle body system able to be actuated by an external force of a motor vehicle.

### DETAILED DESCRIPTION

In an embodiment, the invention provides a method for checking an opening movement and/or a closing movement of a motor vehicle body system able to be actuated by an external force, by means of which such a check can be performed in a particularly straightforward manner.

A method according to an embodiment of the invention for checking an opening movement and/or a closing movement of a motor vehicle body system able to be actuated by an external force comprises the following steps:
energizing an electric drive device of the vehicle body system able to be actuated by an external force such that a movement of the vehicle body system is driven from a closed position to an open position or from the open position to the closed position,
measuring a drive current signal during energizing of the electric drive device, and
checking whether predefined or predefinable current changes, which are given by current gradients and current amplitudes, occur in the drive current signal and whether they exceed or undershoot a predefined or predefinable number during the opening and/or closing operation of the vehicle body system, and/or whether a predefined or predefinable current limit value is exceeded or undershot in the drive current signal during a pinching event within a predefined or predefinable path and/or time interval during the opening and/or closing operation of the vehicle body system.

Using the method according to an embodiment of the invention, which is, e.g., suitable for roof systems, the drive current signal can thus be used to automatically check whether a certain number of relevant current fluctuations (relevant current fluctuations can be defined based on current gradients and current amplitudes) is exceeded or undershot during the opening and/or closing operation of the vehicle body system. For this purpose, only the electric drive current must be determined during the opening or closing operation. Relevant current fluctuations can in particular be defined by the fact that both the amount of the current gradient and the current amplitude exceeds a certain predefined or predefinable threshold value as a function of the travel path of the vehicle body system able to be actuated by an external force, in particular the roof travel path, or the time. By checking current gradients present as well as current amplitudes as a function of the travel path of the vehicle body system able to be actuated by an external force, in particular of the roof travel path, or the time during the opening or closing operation of the vehicle body system able to be actuated by an external force, there is a technically quite straightforward option for both monitoring the mechanical manufacturing quality of the vehicle body system and testing the suitability of the current progression curve with regard to the implementation of an indirect pinch protection system. If the predefined or predefinable number of the relevant current fluctuations are undershot, then it can be deduced that the manufacturing tolerances of the mechanical components of the vehicle body system able to be actuated by an external force have been complied with. In contrast, if the number of relevant current fluctuations is exceeded, this indicates that the manufacturing tolerances of the mechanical components of the vehicle body system able to be actuated by an external force have not been complied with, so reworking may be required. In addition, the method advantageously offers the option of validating component changes within the development process with regard to their influence on the current progression curve. Furthermore, it can, e.g., be evaluated whether a specific roof system is suitable for implementing an indirect pinch protection system by testing the current curve of the roof system for the occurrence of relevant current increases to be defined.

The method can also be used to employ the drive current signal to check whether a predefined or predefinable current limit value is exceeded or undershot within a predefined or predefinable path or time interval during the opening and/or closing operation of the vehicle body system during a pinching event. This in particular enables the determination of whether defined clamping forces are exceeded during an opening and/or closing operation and provides information about the amount of the maximum clamping force.

In an embodiment, it is provided that a Hall signal of a drive motor of the drive device is measured during energizing of the electric drive device. This measure makes it possible to monitor the position of the drive device in particular in an advantageous manner. As a result, for example, it is possible to check whether the legally defined minimum reversing distance of the vehicle body system able to be actuated by an external force is complied with during a pinching event by evaluating the Hall signal of the drive motor. For this purpose, the Hall signal is converted into a roof movement path and the travel path from the occurrence of the pinching event (reverse path) is output.

In an embodiment it is provided that, in the opening position of the vehicle body system able to be actuated by an external force, a test body (of any type) is introduced into an opening region of the vehicle body system before the electric drive device is energized and the drive current signal is measured. As a result, the compliance with the maximum permissible clamping forces in both the development and manufacturing processes is able to be checked in a quite straightforward manner.

Preferably, from the drive current signal, a maximum clamping force of the vehicle body system able to be actuated by an external force can be calculated during the pinching event.

In an embodiment, it can be provided that energizing of the drive device is initiated by actuation of an operating element or by means of an external control device.

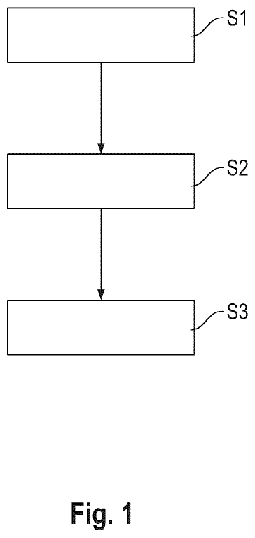

Further features and advantages of embodiments of the present invention will become apparent from the following description of a preferred exemplary embodiment with reference to FIG. 1, which illustrates the basic sequence of a method for checking an opening movement and/or closing movement of a vehicle body system able to be actuated by an external force of a motor vehicle. Examples of motor vehicle body systems able to be actuated by an external forces, whose opening movement and/or closing movement is driven by means of an electric drive device associated with them, include roof opening systems, in particular sliding roof systems or convertible top systems, in particular side windows, doors, trunk lids, tailgates, and front lids of a motor vehicle.

Experience has shown that the quality of the roof opening of the roof opening systems, in particular sliding roof systems, is dependent on manufacturing tolerances of the installed mechanical components to a particular extent.

In electromotor-driven windows, in particular side windows, doors comprising an electromotor-driven automatic closing system, trunk lids, tailgates and front lids, it is also important to provide effective pinch protection. Legal requirements are placed on such pinch protection of vehicle body systems able to be actuated by an external forces, in particular with regard to the maximum clamping forces to be observed and the minimum reversing paths. Compliance is currently ensured by means of a comparatively complex mechanical force measurement in both the development and the manufacturing process. Currently, the prescribed reverse path can only be assessed by means of a mechanical path measurement.

In a method according to an exemplary embodiment of the present invention for checking an opening movement and/or a closing movement of a motor vehicle body system able to be actuated by an external force, the electric drive device of the vehicle body system able to be actuated by an external force is first powered in step S1 such that a movement of the vehicle body system is driven from a closed position to an open position, or from the open position to the closed position. Energizing of the drive device is initiated in particular by actuation of an operating element or by means of an external control device.

In step S2, a drive current signal is continuously measured during energizing of the electric drive device. Optionally, in this method step S2 a Hall signal of a drive motor of the electric drive device is also measured in order to monitor the position of the electric drive motor.

In step S3, it is then checked whether predefined or predefinable current changes (defined by current gradients and current amplitudes) occur in the drive current signal and whether they exceed or undershoot a predefined or predefinable number during the opening and/or closing operation of the vehicle body system, and/or whether a predefined or pre-definable current limit value is exceeded or undershot in the drive current signal during a pinching event within a predefined or predefinable path and/or time interval during the opening and/or closing operation of the vehicle body system.

Using the method presented herein, it is thus in particular possible to automatically check whether the predefined or predefinable number of relevant current fluctuations during the opening and/or closing operation of the vehicle body system are exceeded or undershot based on the measurement and evaluation of the drive current signal. For this purpose, only the drive current for the electric drive device and optionally the Hall signal of the drive motor of the electric drive device must be determined during the opening or closing operation and evaluated accordingly.

Checking the number of relevant current fluctuations during the opening or closing operation of the vehicle body system able to be actuated by an external force provides a technically quite straightforward way of, e.g., monitoring the mechanical manufacturing quality of the vehicle body system able to be actuated by an external force. If the predefined or predefinable number of the relevant current fluctuations is undershot, it can be deduced that the manufacturing tolerances of the mechanical components of the vehicle body system able to be actuated by an external force have been complied with. In contrast, if the number of relevant current fluctuations is exceeded, this indicates that the manufacturing tolerances of the mechanical components of the vehicle body system able to be actuated by an external force have not been complied with, so reworking may be required.

The method presented herein can, e.g., be used to automatically check during the development or manufacturing process whether a permissible clamping force is exceeded or undershot when the vehicle body system able to be actuated by an external force is closed. For this purpose, in the opening position of the vehicle body system able to be actuated by an external force, a test body is introduced into an opening region of the vehicle body system before subsequently energizing the electric drive device to initiate the closing movement. By measuring and evaluating the drive current signal as a function of the roof travel path (optionally also as a function of time), it can be checked whether or not the maximum permissible clamping force is exceeded at least once when the vehicle body system interacts with the test body. Preferably, the maximum clamping force can, e.g., also be calculated from the drive current signal and output by means of a display device.

The disclosed method for determining whether the maximum permissible clamping force has been exceeded or undershot by measuring and evaluating the drive current signal of the electric drive device makes it advantageously possible to significantly reduce the test effort and test complexity. This is particularly advantageous with regard to the cycle time when testing effective anti-pinch protection during ongoing manufacturing process.

In addition, there is a significant reduction in the likelihood of erroneous measurements that are very common in mechanical clamping force measurements. Due to their complexity, mechanical clamping force measurements are relatively susceptible to measurement inaccuracies, which often result from application errors.

In addition, the information content of the clamping force test can also be advantageously increased because the detection and analysis of the current progression curve of the drive current signal also enables a plausibility check to be performed compared to the conventional mechanical measurement of clamping forces.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for checking an opening movement and/or a closing movement of a motor vehicle body system able to be actuated by an external force, the method comprising:
energizing an electric drive device of the vehicle body system such that a movement of the vehicle body system is driven from a closed position to an open position or from the open position to the closed position;
measuring a drive current signal during energizing of the electric drive device; and
checking whether predefined or predefinable current changes, which are given by current gradients and current amplitudes, occur in the drive current signal and whether the predefined or predefinable current changes exceed or undershoot a predefined or predefinable value during the opening and/or closing operation of the vehicle body system, and/or whether a predefined or predefinable current limit value is exceeded or undershot in the drive current signal during a pinching event within a predefined or predefinable path and/or time interval during the opening and/or closing operation of the vehicle body system.

2. The method according to claim 1, comprising receiving a test body in an opening region of the vehicle system in the open position before the electric drive device is energized and the drive current signal is measured.

3. The method according to claim 2, comprising calculating a maximum clamping force of the vehicle body system during the pinching event from the drive current signal.

4. The method according to claim 3, comprising checking whether the maximum clamping force exceeds a predefined or predefinable permissible clamping force.

5. The method according to claim 1, comprising measuring a Hall signal of a drive motor of the electric drive device during energizing of the electric drive device.

6. The method according to claim 1, comprising initiating energizing of the electric drive device by actuation of an operating element or by an external control device.
